(19) United States
(12) Patent Application Publication
(10) Pub. No.: US 2010/0278934 A1
(43) Pub. Date: Nov. 4, 2010

(54) METHODS AND COMPOSITIONS FOR CONSERVING AND/OR PREPARING AN ORGAN OR TISSUE FOR TRANSPLANT

(75) Inventors: Jack Finkelstein, JR., Chevy Chase, MD (US); C. Neil Lyons, Highland, MD (US)

Correspondence Address: ROTHWELL, FIGG, ERNST & MANBECK, P.C., 1425 K STREET, N.W., SUITE 800, WASHINGTON, DC, 20005, US

(73) Assignee: Regenerx Biopharmaceuticals Inc., Bethesda, MD (US)

(21) Appl. No.: 12/377,939

(22) PCT Filed: Aug. 6, 2007
(86) PCT No.: PCT/US07/17483

§ 371 Date: Feb. 18, 2009

Related U.S. Application Data
(60) Provisional application No. 60/838,383, filed on Aug. 18, 2006.

(51) Int. Cl. A01N 1/02

(52) U.S. Cl. 424/605; 435/1.1; 514/12.9; 435/1.2; 424/697

(57) ABSTRACT

A method of conserving and/or preparing an organ or tissue for transplant for a subject, includes administering to a subject, organ or tissue in need of such treatment an effective amount of a composition including a polypeptide agent including thymosin beta 4 (TB4), an isoform, analogue or derivative of TB4 having biological activity of TB4, an N-terminal variant of TB4 having biological activity of TB4, a C-terminal variant of TB4 having biological activity of TB4, LKKTET or a conservative variant thereof, LKKTNT or a conservative variant thereof, KLKKTET or a conservative variant thereof, LKKTETQ or a conservative variant thereof, TB4 sulfoxide, TB4ala, TB9, TB10, TB11, TB12, TB13, TB14, TB15, gelsolin, vitamin D binding protein (DBP), profilin, cofilin, adsevertin, propomyosin, fincilin, depactin, Dnasel, vilin, fragmin, severin, capping protein, ?-actinin or acumentin, or a stimulating agent that stimulates production of a polypeptide agent as described above, or a conservative variant thereof, in the organ or tissue.

### CROSS-REFERENCE TO RELATED APPLICATION

This application claims benefit of U.S. Provisional Application No. 60/838,383, filed Aug. 18, 2006.

### BACKGROUND OF THE INVENTION

1. Field of the Invention

The present invention relates to the field of conserving and/or preparing an organ or tissue for transplant.

2. Description of the Background Art

Hypothermia is utilized in most methods of organ and tissue preservation, and has proven to be most effectively applied by controlling the extracellular environment of cells directly, and the intracellular environment indirectly, during cold exposure. Control of the extracellular environment of cells to optimise preservation is based upon different strategies that include either static cold storage (or flush preservation), or low temperature continuous perfusion. These strategies call for varied approaches to interventional control of the extracellular environment in order to optimize preservation, and hence different design elements for the solutions used to effect these strategies.

In principle, cold flush storage or preservation is based upon the premise that temperature reduction to near but not below the ice point (e.g., about 0° C.) precludes the need to support metabolism to any significant extent, and that the correct distribution of water and ions between the intracellular and extracellular compartments can be maintained by physical rather than metabolic means. During a period that metabolic pumps are inactivated, the driving force for transmembrane ion flux is the difference in ionic balance between intracellular and extracellular fluid. The driving force for water uptake (cell swelling) is the impermeant intracellular anions. Thus changes can be prevented or restricted by manipulating the extracellular environment to abolish chemical potential gradients. On this basis, a variety of flush, or organ and tissue washout, solutions have been devised and evaluated for cold storage. These solutions are often referred to as “intracellular” solutions due to their resemblance, in some respects, to intracellular fluid.

The principle design elements of the “intracellular” flush solutions have been to adjust the ionic balance (notably of the monovalent cations) and to raise the osmolality by including an impermeant solute to balance the intracellular osmotic pressure responsible for water uptake. However, an important factor for the efficacy of cold flush solutions may be the prevention of cellular edema by inclusion of impermeant solutes since it has been established that ionic imbalances, especially potassium depletion, are readily and rapidly reversible. These methods stabilize the organs and tissues for about 4-36 hours.

Prior to 1988, a standard solution for clinical preservation of organs and tissues was Collins solution, which includes potassium phosphate, magnesium sulfate and glucose. In recent years, however, this has been superseded either by a modified version called “Euro-Collins” in which the magnesium sulfate is omitted, or more extensively by the University of Wisconsin solution (UW solution) in which much of the phosphate anion has been replaced with lactobionate, and in which glucose has been replaced with raffinose. These larger molecules appear to improve protection against adverse effects of cell swelling during hypothermic storage, as compared to prior solutions.

There remains a need in the art for improved methods and compositions for conservation and preparation of organs and tissues for transplant.

### SUMMARY OF THE INVENTION

In accordance with one aspect, a method and composition for conserving and/or preparing an organ or tissue, for transplant for a subject, involves administering to an organ, tissue or a subject, an effective amount of a composition comprising a polypeptide agent comprising thymosin beta 4 (TB4), an isoform, analogue or derivative of TB4 having biological activity of TB4, an N-terminal variant of TB4 having biological activity of TB4, a C-terminal variant of TB4 having biological activity of TB4, LKKTET or a conservative variant thereof, LKKTNT or a conservative variant thereof, KLKKTET or a conservative variant thereof, LKKTETQ or a conservative variant thereof, TB4 sulfoxide, TB4^{ala}, TB9, TB10, TB11, TB12, TB13, TB14, TB15, gelsolin, vitamin D binding protein (DBP), profilin, cofilin, adsevertin, propomyosin, fincilin, depactin, Dnasel, vilin, fragmin, severin, capping protein, β-actinin or acumentin, or a stimulating agent that stimulates production of said polypeptide, or a conservative variant thereof, in said organ or tissue, so as to conserve and prepare an organ or tissue for transplant.

### DETAILED DESCRIPTION OF THE INVENTION

Without being found to any specific theory, actin-sequestering polypeptides such as thymosin beta 4 (T [symbol] 4 or TB4) and other agents including actin-sequestering polypeptides or polypeptide fragments containing amino acid sequence LKKTET or LKKTNT or conservative variants thereof, conserve and prepare an organ or tissue for transplant.

Thymosin beta 4 was initially identified as a protein that is up-regulated during endothelial cell migration and differentiation in vitro. Thymosin beta 4 was originally isolated from the thymus and is a 43 amino acid, 4.9 kDa ubiquitous polypeptide identified in a variety of tissues. Several roles have been ascribed to this protein including a role in a endothelial cell differentiation and migration, T cell differentiation, actin sequestration, vascularization and wound healing.

A composition according to the invention may be administered to an organ or tissue which is present inside or outside of a transplant donor or transplant recipient.

In accordance with one embodiment, the invention is a method of conserving and/or preparing an organ or tissue for transplant for a subject, comprising administering to an organ or tissue outside a subject an effective amount of a composition comprising a polypeptide agent comprising thymosin beta 4 (TB4), an isoform, analogue or derivative of TB4 having biological activity of TB4, an N-terminal variant of TB4 having biological activity of TB4, a C-terminal variant of TB4 having biological activity of TB4, LKKTET or a conservative variant thereof, LKKTNT or a conservative variant thereof, KLKKTET or a conservative variant thereof, LKKTETQ or a conservative variant thereof, TB4 sulfoxide, TB4^{ala}, TB9, TB10, TB11, TB12, TB13, TB14, TB15, gelsolin, vitamin D binding protein (DBP), profilin, cofilin, adsevertin, propomyosin, fincilin, depactin, Dnasel, vilin, fragmin, severin, capping protein, β-actinin or acumentin, which may be a polypeptide comprising amino acid sequence LKKTET or LKKTNT, or a conservative variant thereof, which conserves and/or prepares an organ or tissue for transplant. The polypeptide agent preferably is Thymosin [symbol] 4, and/or Tβ4 isoforms, analogues or derivatives thereof. Examples include polypeptides containing amino acid sequence is KLKKTET, LKKTETQ, N-terminal variants of Tβ4 and C-terminal variants of Tβ4. The invention also may utilize oxidized Tβ4. In accordance with other embodiments, the polypeptide agent is other than thymosin beta 4 or oxidized Tβ4.

In accordance with another embodiment. the invention is a method of conserving and/or preparing an organ or tissue for transplant for a subject, which is either a donor or a transplant recipient, comprising administering to an organ or tissue inside a subject an effective amount of a composition comprising a polypeptide agent comprising thymosin beta 4 (TB4), an isoform, analogue or derivative of TB4 having biological activity of TB4, an N-terminal variant of TB4 having biological activity of TB4, a C-terminal variant of TB4 having biological activity of TB4, LKKTET or a conservative variant thereof, LKKTNT or a conservative variant thereof, KLKKTET or a conservative variant thereof, LKKTETQ or a conservative variant thereof, TB4 sulfoxide, TB4^{ala}, TB9, TB10, TB11, TB12, TB13, TB14, TB15, gelsolin, vitamin D binding protein (DBP), profilin, cofilin, adsevertin, propomyosin, fincilin, depactin, Dnasel, vilin, fragmin, severin, capping protein, β-actinin or acumentin, which may be a polypeptide comprising amino acid sequence LKKTET or LKKTNT, or a conservative variant thereof, which conserves and/or prepares an organ or tissue for transplant. The polypeptide agent preferably is Thymosin [symbol] 4, and/or Tβ4 isoforms, analogues or derivatives thereof. Examples include polypeptides containing amino acid sequence KLKKTET, LKKTETQ. N-terminal variants of Tβ4 or C-terminal variants of Tβ4. The invention also may utilize oxidized Tβ4. In accordance with other embodiments, the antimicrobial agent is other than thymosin beta 4 or oxidized Tβ4.

The organ may include but is not limited to skin, heart, liver, kidney, pancreas, small bowel, or lung. The tissue may include but is not limited to skin, heart, heart valve, bone, bone marrow, blood vessels, and blood for transfusion.

Compositions which may be used in accordance with the present invention include a polypeptide agent comprising thymosin beta 4 (TB4), an isoform, analogue or derivative of TB4 having biological activity of TB4, an N-terminal variant of TB4 having biological activity of TB4, a C-terminal variant of TB4 having biological activity of TB4, LKKTET or a conservative variant thereof, LKKTNT or a conservative variant thereof, KLKKTET or a conservative variant thereof, LKKTETQ or a conservative variant thereof, TB4 sulfoxide, TB4^{ala}, TB9, TB10, TB11, TB12, TB13, TB14, TB15, gelsolin, vitamin D binding protein (DBP), profilin, cofilin, adsevertin, propomyosin, fincilin, depactin, Dnasel, vilin, fragmin, severin, capping protein, β-actinin or acumentin, e.g., polypeptide agents such as Thymosin β4 (Tβ4), and/or Tβ4 isoforms, analogues or derivatives, including oxidized Tβ4, N-terminal variants of Tβ4 and/or C-terminal variants of Tβ4, polypeptides or polypeptide fragments comprising or consisting essentially of the amino acid sequence LKKTET or LKKTNT or conservative variants thereof, which conserve and/or prepare an organ or tissue for transplant. International Application Ser. No. PCT/US99/17282, incorporated herein by reference, discloses isoforms of T [symbol] 4 which may be useful in accordance with the present invention as well as amino acid sequence LKKTET or LKKTNT, or conservative variants thereof, which may be utilized with embodiments of the present invention. International Application Ser. No. PCT/GB99/00833 (WO 99/49883), incorporated herein by reference, discloses oxidized Thymosin [symbol] 4 which may be utilized in accordance with embodiments of the present invention. Although the present invention is described primarily hereinafter with respect to Tβ4 and Tβ4 isoforms, it is to be understood that the following description is intended to be equally applicable to amino acid sequence LKKTET or LKKTNT, polypeptides and fragments comprising or consisting essentially of LKKTET or LKKTNT, conservative variants thereof, which conserve and prepare an organ or tissue for transplant, and/or Tβ4 isoforms, analogues or derivatives, including N-terminal variants of Tβ4, C-terminal variants of Tβ4 and antagonists of Tβ4. The invention also may utilize oxidized Tβ4.

One known transplant solution is the University of Wisconsin solution which may contain, for example: KH₂PO₄ (25 mmol/L), MgSO₄ (5 mmol/L), Raffinose (30 mmol/L), Hydroxyethyl Pentafraction Starch (50 g/L), Penicillin (200,000 U/L), Insulin (40 U/L), Dexamethasone (16 mg/dL), K Lactobionate (100 mmol/L), Glutathione Stimulating Hormone (3 mmol/L), Adenosine 5 (mmol/L), Allopurinol (1 mmol/L), Na (25 mmol/L), and K (125 mmol/L). A polypeptide agent such as thymosin β4 (Tβ4), and/or Tβ4 isoforms may be added to such a solution in amounts, for example, within the range of about 0.001-50% by weight.

Another known transplant solution is the Euro-Collins solution which may contain, for example: Sodium (10 mM), Chloride (15 mM), Potassium (115 mM), Bicarbonate (10 mM), Phosphate (50 mM) and Glucose (195 mM). A polypeptide agent such as thymosin β4 (Tβ4), and/or Tβ4 isoforms may be added to such a solution in amounts, for example, within the range of about 0.001-50% by weight.

In one embodiment, the invention provides a method of conserving and/or preparing an organ or tissue for transplant, for a subject, comprising administering to an organ or tissue outside a subject, an effective amount of a composition comprising a polypeptide agent comprising amino acid sequence LKKTET or LKKTNT, a conservative variant thereof, or a stimulating agent that stimulates production, in said organ or tissue of an LKKTET or LKKTNT polypeptide, or a conservative variant thereof, so as to conserve and/or prepare the organ or tissue for transplant.

In another embodiment, the invention provides a method of conserving and preparing an organ or tissue for transplant, comprising administering to an organ or tissue inside a subject, an effective amount of a composition comprising a polypeptide agent comprising amino acid sequence LKKTET or LKKTNT, a conservative variant thereof, or a stimulating agent that stimulates production, in said organ or tissue, of an LKKTET or LKKTNT polypeptide, or a conservative variant thereof, in said organ or tissue, so as to conserve and/or prepare the organ or tissue for transplant.

The organ may include but is not limited to skin, heart, liver, kidney, pancreas, small bowel, or lung. The tissue may include but is not limited to skin, heart, heart valve, bone, bone marrow, blood vessels, and blood for transfusion.

In one embodiment, the invention provides a method of conserving and/or preparing an organ or tissue for transplant, for a subject, by contacting an organ or a tissue with an effective amount of a composition which contains a polypeptide agent as described herein. The contacting may be directly or systemically. Examples of direct administration include, for example, contacting the tissue, by direct application, with a solution, lotion, salve, gel, cream, paste, spray, suspension, dispersion, hydrogel, foam, ointment, or oil comprising a polypeptide agent as described herein. Administration of the agent may include static cold storage, low temperature continuous perfusion, or any other suitable method, preferably at a temperature within a range of about −520 to about 10° C., more preferably within a temperature range of about −1° to about 6° C., still more preferably within a temperature range of about 0° to about 5° C., carried out by perfusion, injection, infusion, topically, or a combination thereof using a composition containing a polypeptide agent as described herein, in a transplant solution, or pharmaceutically acceptable carrier which may comprise water for injection.

Many T [symbol] 4 isoforms have been identified and have about 70%, or about 75%, or about 80% or more homology to the known amino acid sequence of T [symbol] 4. Such isoforms include, for example, Tβ4^{ala}, T [symbol] 9, Tβ10, T [symbol] 11, Tβ12, Tβ13, Tβ14 and T [symbol] 15. Similar to Tβ4, the T [symbol] 10 and T [symbol] 15 isoforms have been shown to sequester actin. T [symbol] 4, Tβ10 and T [symbol] 15, as well as these other isoforms share an amino acid sequence, LKKTET or LKKTNT, that appears to be involved in mediating actin sequestration or binding. Although not wishing to be bound by any particular theory, the activity of polypeptide agents as described herein may be due, at least in part, to the anti-inflammatory activity of such agents. Tβ4 also can modulate actin polymerization (e.g. [symbol] -thymosins appear to depolymerize F-actin by sequestering free G-actin). T [symbol] 4's ability to modulate actin polymerization may be due to its ability to bind to or sequester actin via the LKKTET or LKKTNT sequence. Thus, as with T [symbol] 4, other proteins which are anti-inflammatory and/or bind or sequester actin, or modulate actin polymerization, including T [symbol] 4 isoforms having the amino acid sequence LKKTET or LKKTNT, are likely to be effective, alone or in a combination with Tβ4, as set forth herein.

Thus, it is specifically contemplated that known LKKTET or LKKTNT polypeptides as described herein, including T [symbol] 4 isoforms, such as Tβ4^{ala}, T [symbol] 9, Tβ10, Tβ11, Tβ12, Tβ13, Tβ14 and Tβ15, as well as T [symbol] 4 isoforms not yet identified, will be useful in the methods of the invention, tissue or organ. As such LKKTET or LKKTNT . polypeptides as describes herein, including Tβ4 isoforms are useful in the methods of the invention, including the methods practiced in a subject, tissue or organ. The invention therefore further provides compositions comprising LKKTET or LKKTNT polypeptides as described herein, including T [symbol] 4, as well as T [symbol] 4 isoforms T [symbol] 4^{ala}, T [symbol] 9, T [symbol] 10, T [symbol] 11, T [symbol] 12, Tβ13, T [symbol] 14 and T [symbol] 15, and a transplant and/or pharmaceutically acceptable carrier.

In addition, other agents or proteins having anti inflammatory activity and/or actin sequestering or binding capability, or that can mobilize actin or modulate actin polymerization, as demonstrated in an appropriate sequestering, binding, mobilization or polymerization assay, or identified by the presence of an amino acid sequence that mediates actin binding, such as LKKTET or LKKTNT, for example, can similarly be employed in the methods of the invention. Such proteins may include gelsolin, vitamin D binding protein (DBP), profilin, cofilin, depactin, Dnasel, vilin, fragmin, severin, capping protein, β-actinin and acumentin, for example. As such methods include those practiced in a subject, the invention further provides compositions comprising gelsolin, vitamin D binding protein (DBP), profilin, cofilin, depactin, Dnasel, vilin, fragmin, severin, capping protein, β-actinin and acumentin as set forth herein. Thus, the invention includes the use of an polypeptide comprising the amino acid sequence LKKTET or LKKTNT and conservative variants thereof.

As used herein, the term “conservative variant” or grammatical variations thereof denotes the replacement of an amino acid residue by another, biologically similar residue. Examples of conservative variations include the replacement of a hydrophobic residue such as isoleucine, valine, leucine or methionine for another, the replacement of a polar residue for another, such as the substitution of arginine for lysine, glutamic for aspartic acids, or glutamine for asparagine, and the like.

Tβ4 has been localized to a number of tissue and cell types and thus, agents which stimulate the production of an LKKTET or LKKTNT polypeptide such as T [symbol] 4 or another polypeptide agent as described herein, can be added to or comprise a composition to effect production a polypeptide agent from a tissue and/or a cell. Such stimulating agents may include members of the family of growth factors, such as insulin-like growth factor (IGF-1), platelet derived growth factor (PDGF), epidermal growth factor (EGF), transforming growth factor beta (TGF- [symbol] ), basic fibroblast growth factor (bFGF), thymosin [symbol] 1 (T [symbol] 1) and vascular endothelial growth factor (VEGF). More preferably, the stimulating agent is transforming growth factor beta (TGF-β) or other members of the TGF-β superfamily.

In accordance with one embodiment, a subject, organ or tissue is treated with a stimulating agent that stimulates production in the subject, organ or tissue is of a polypeptide agent as defined herein.

Additionally, other agents that assist in conserving and preparing an organ or tissue for transplant may be added to a composition along with a polypeptide agent as described herein. For example, and not by way of limitation, a polypeptide agent as described herein alone or in combination can be added in combination with any one or more of the following agents: antibiotics, VEGF, KGF, FGF, PDGF, TGF [symbol] , IGF-1, IGF-2, IL-1, prothymosin [symbol] and/or thymosin [symbol] 1 in an effective amount.

The invention also includes a composition comprising a therapeutically effective amount of a polypeptide agent as described herein in a transplant and/or pharmaceutically acceptable carrier.

The actual dosage or reagent, formulation or composition that provides treatment may depend on many factors, including the size and health of the organ, tissue or subject. However, persons of ordinary skill in the art can use any suitable method such as those well known in the art to determine the appropriate dosage to use.

Suitable formulations may include a polypeptide agent as described herein at a concentration within the range of about 0.001-50% by weight, more preferably within the range of about 0.01-0.1% by weight, most preferably about 0.05% by weight.

The approaches described herein involve various routes of administration or delivery of a polypeptide agent as described herein, including any conventional administration techniques (for example, but not limited to, perfusion, injection, infusion, or topically), to a subject. The methods and compositions using or containing a polypeptide agent as described herein may be formulated into pharmaceutical compositions by admixture with transplant and/or pharmaceutically acceptable non-toxic excipients or carriers.

The invention includes use of antibodies which interact with, enhance or inhibit a polypeptide agent as described herein. Antibodies which consist essentially of pooled monoclonal antibodies with different epitopic specificities, as well as distinct monoclonal antibody preparations are provided. Monoclonal antibodies are made from antigen containing fragments of the protein by methods well known to those skilled in the art as disclosed in PCT/US99/17282, supra. The term antibody as used in this invention is meant to include monoclonal and polyclonal antibodies.

In yet another embodiment, the invention provides a method of treating a subject by administering an effective amount of stimulating agent which modulates gene expression. The term “modulate” refers to inhibition or suppression of expression when a polypeptide agent as described herein is over expressed, and induction of expression when a polypeptide agent as described herein is underexpressed. The term “effective amount” means that amount of stimulating agent which is effective in modulating gene expression of a polypeptide agent as described herein, resulting in conserving and/or preparing an organ or tissue for transplant. A stimulating agent which modulates gene expression of a polypeptide agent as described herein may be a polynucleotide, for example. The polynucleotide may be an antisense, a triplex agent, or a ribozyme. For example, an antisense directed to the structural gene region or to the promoter region of a polypeptide agent as described herein may be utilized. The stimulating agent which modulates gene expression of a polypeptide agent as described herein may also be a small interfering RNAs (siRNAs).

In another embodiment, the invention provides a method for utilizing compounds that modulate activity of a polypeptide agent as described herein. Compounds that affect activity of a polypeptide agent as described herein (e.g., antagonists and agonists) include polypeptides, peptidomimetics, polypeptides, chemical compounds, minerals such as zincs, and biological agents.

A method for screening for a stimulating agent as defined herein, comprises contacting a tissue or organ for transplant, with a candidate compound; and measuring activity in said tissue of an LKKTET or LKKTNT polypeptide, wherein an increase of activity of said peptide in said tissue or organ, compared to a level of activity of said polypeptide in a corresponding tissue or organ lacking said candidate compound, indicates that said compound is capable of inducing said stimulating agent.

### EXAMPLE 1

### Material and Methods

Human hepatic stellate cells HSC were obtained from a liver cell mixture purchased from ADMET technologies after separation on an OptiPrep® Density Gradient Medium (Sigma). They were cultured until confluent and then plated at a density of 250,000 cells/60-mm dish and cultured in MEM supplemented with 10% bovine fetal serum, 1% non-essential amino acids and antibiotics. The cells were maintained in culture for approximately 48 hours and when semi-confluent they were serum-starved overnight using MEM supplemented with 1% albumin, antibiotics and 1% non-essential amino acids. RNA was extracted with Trizol (Invitrogen) and RT-PCR performed using primers. The expression of GAPDH was used as a control. All the experiments were performed in duplicate.

### RESULTS

PCR analysis of RNA extracted from HSC cultured for 24 hours with different concentrations of Tβ4 revealed that the expression of α-SMA mRNA, a marker of differentiated HSC, and of β-catenin and GSK 3β mRNAs, gene members of the Wnt pathway that may be involved in their differentiation, were increased 4-fold, 3-fold and 2.5-fold respectively. In many instances, the increase was dose dependent. Maximal expression of α-SMA was obtained with 1 μg/ml of Tβ4,while the maximal increase in β-catenin mRNA was achieved with 1 ng/ml. The expression of another marker of HSC differentiation, namely PDGF-β receptor, was inhibited in a dose-dependent manner (75% with 1 μg/ml of Tβ4). Interestingly, the expression of HGF mRNA, a known antifibrogenic cytokine that plays a key role in hepatocyte regeneration, was increased 4-fold with 1 mg/ml of Tβ4.

Hepatocyte Growth Factor (HGF) is a trophic factor for hepatocytes. The above demonstrates that Tβ4 up-regulates the expression of HGF by hepatic stellate cells. Co-cultures of rat HSC and Human hepatocytes are prepared. Controls are incubated with the regular hormonally-defined medium used for hepatocytes. Experimental cultures receive greater than 100 ng/ml of Tβ4 in the same culture medium. Cells are harvested after one week using collagenase and trypsin. The hepatocytes are separated from the HSC by low speed centrifugation and the cells counted and used for total RNA extraction. The hepatocytes proliferate and increase in number after one week in culture. The purity of the cell fractions are determined after staining with anti-human albumin antibodies (rat HSC are negative). RNA is used for RT-PCR and the expression of liver specific genes analyzed using human primers. Rat primers are used to determine the degree of contamination of rat HSC.

1. A method for conserving or preparing an organ or tissue for transplant comprising contacting the organ or tissue with a composition comprising a polypeptide agent comprising thymosin beta 4 (TB4), an isoform; analogue or derivative of TB4 having biological activity of TB4, an N-terminal variant of TB4 having biological activity of TB4, a C-terminal variant of TB4 having biological activity of TB4, LKKTET or a conservative variant thereof, LKKTNT or a conservative variant thereof, KLKKTET or a conservative variant thereof, LKKTETQ or a conservative variant thereof, TB4 sulfoxide, TB4^{ala}, TB9, TB10, TB11, TB12, TB13, TB14, TB15, gelsolin, vitamin D binding protein (DBP), profilin, cofilin, adsevertin, propomyosin, fincilin, depactin, Dnasel, vilin, fragmin, severin, capping protein, β-actinin or acumentin, or a stimulating agent that stimulates production of said polypeptide agent, or a conservative variant thereof, in said organ or tissue, so as to conserve or prepare said organ or tissue for transplant.

2. The method of claim 1 wherein said contacting is outside a subject's body.

3. The method of claim 1 wherein said contacting is inside a subject's body.

4. The method of claim 1 wherein said organ or tissue is perfused with said composition while inside a subject's body.

5. The method of claim 4 wherein said body is of a donor of said organ or tissue.

6. The method of claim 4 wherein said body is of a transplant recipient of said organ or tissue.

7. The method of claim 1 wherein said tissue is skin, heart, heart valve, bone, bone marrow, blood vessels, or blood for transfusion.

8. The method of claim 1 wherein said organ is a heart, liver, kidney, pancreas, small bowel, or lung.

9. The method of claim 1 wherein said composition preserves said organ or tissue for transplant.

10. The method of claim 1 wherein said polypeptide agent is a recombinant or synthetic polypeptide.

11. The method of claim 1 wherein said composition comprises Tβ4 or an isoform of Tβ4.

12. The method of claim 1 wherein said polypeptide agent comprises amino acid sequence KLKKTET, amino acid sequence LKKTETQ, an N-terminal variant of Tβ4, a C-terminal variant of Tβ4,or an isoform of Tβ4.

13. The method of claim 1 wherein the composition is administered either directly or systematically.

14. The method of claim 1 wherein said composition is administered directly in the form of a solution, gel, creme, paste, lotion, spray, suspension, dispersion, salve, hydrogel, foam or ointment formulation.

15. The method of claim 1 wherein said polypeptide agent is administered to said organ or tissue by static cold storage or low temperature continuous perfusion, at a temperature within in a range of about −5° to about 10° C., administered by perfusion, injection, infusion, topically or a combination thereof.

16. The method of claim 1 wherein said composition further comprises an aqueous solution and at least one of potassium phosphate, magnesium sulfate, glucose, lactobionate or raffinose.

17. A composition for conserving or preparing an organ or tissue for transplant, comprising a polypeptide agent comprising thymosin beta 4 (TB4), an isoform, analogue or derivative of TB4 having biological activity of TB4, an N-terminal variant of TB4 having biological activity of TB4, a C-terminal variant of TB4 having biological activity of TB4, LKKTET or a conservative variant thereof, LKKTNT or a conservative variant thereof, KLKKTET or a conservative variant thereof, LKKTETQ or a conservative variant thereof, TB4 sulfoxide, TB4^{ala}, TB9, TB10, TB11, TB12, TB13, TB14, TB15, gelsolin, vitamin D binding protein (DBP), profilin, cofilin, adsevertin, propomyosin, fincilin, depactin, Dnasel, vilin, fragmin, severin, capping protein, β-actinin or acumentin, or a stimulating agent that stimulates production in said organ or tissue of said polypeptide agent, or a conservative variant thereof, said composition further comprising an aqueous solution and at least one of potassium phosphate or lactobionate, and at least one of glucose or raffinose.

18. The composition of claim 17 comprising Tβ4 or an isoform of Tβ4.

19. The composition of claim 17 comprising Tβ4.

20. The method of claim 1 wherein said composition comprises Tβ4.
